(19) United States
(12) Patent Application Publication
(10) Pub. No.: US 2020/0400108 A1
(43) Pub. Date: Dec. 24, 2020

(54) EXHAUST MANIFOLD WITH INTEGRATED EXHAUST GAS RECIRCULATION VALVE

(71) Applicant: GM Global Technology Operations LLC, Detroit, MI (US)

(72) Inventors: Michael Kaczmar, Farmington Hills, MI (US); Kenneth M. Eastman, Troy, MI (US)

(21) Appl. No.: 16/444,399

(22) Filed: Jun. 18, 2019

(51) Int. Cl. F02M 26/70; F02D 9/10; F02M 35/108; F02B 31/08; F02M 26/38

(52) U.S. Cl. CPC F02M 26/70; F02D 9/1045; F02M 26/38; F02B 31/085; F02M 35/108

(57) ABSTRACT

A vehicle engine exhaust system with integrated exhaust gas recirculation (EGR) includes an exhaust manifold having multiple exhaust ports including a first exhaust port and a second exhaust port. The first exhaust port and the second exhaust port receive exhaust flow from a common exhaust split upstream of the first exhaust port and the second exhaust port. A valve assembly has a first butterfly valve positioned in the first exhaust port and a second butterfly valve positioned in the second exhaust port. A shaft is positioned within the exhaust manifold commonly connecting the first butterfly valve to the second butterfly valve to simultaneously rotate the first butterfly valve and the second butterfly valve.

### INTRODUCTION

The present disclosure relates to vehicle engine exhaust gas recirculation (EGR) systems and more specifically to an EGR valve integrated within an exhaust manifold.

Most modern engines now use exhaust gas recirculation (EGR) systems to meet emissions standards. EGR works by recirculating a portion of an engine's exhaust gas back to the engine cylinders. Vehicle engine EGR systems are known that position an EGR valve external to an engine exhaust manifold to redirect exhaust gas flow back to an intake manifold. EGR systems are commonly used in gasoline and diesel engine designs. In a gasoline engine, the inert recirculated exhaust gas displaces an amount of combustible matter in the cylinders. In a diesel engine, the exhaust gas replaces some of the excess oxygen in a pre-combustion mixture. Because nitrogen oxide (NOx) forms primarily when a mixture of nitrogen and oxygen is subjected to high temperature, the lower combustion chamber temperatures achieved during EGR injection reduces the amount of NOx generated during fuel combustion, at some loss of engine efficiency. Gasses re-introduced from EGR systems will also contain near equilibrium concentrations of NOx and carbon monoxide (CO), the small fraction initially within a combustion chamber inhibiting total net production of these pollutants.

EGR valves and systems have been common in automobile emission control systems since the early 1970's. EGR valves are operated at predetermined operating conditions of the engine such as during engine startup and when the engine has not achieved normal operating temperature or load. The EGR valve reroutes a portion of the exhaust gases discharged into an exhaust header back into an air intake manifold, which lowers combustion temperature to a predetermined temperature, thereby limiting formation of NOx. The predetermined temperature commonly used is 2,500 degrees Fahrenheit (approximately 1357 degrees Centigrade).

Exhaust gas recirculation systems can also include filters to remove soot and particles and pass the filtered gas back into the engine during a combustion cycle. Known EGR valve and EGR system components are add-on components that therefore impact engine compartment design by reducing available space within the engine compartment.

Thus, while current vehicle EGR systems and valves achieve their intended purpose, there is a need for a new and improved EGR system and system operation.

### SUMMARY

According to several aspects, a vehicle engine exhaust system with integrated exhaust gas recirculation (EGR) includes an exhaust manifold. The exhaust manifold includes multiple exhaust ports including a first exhaust port and a second exhaust port. The first exhaust port and the second exhaust port receive exhaust flow split upstream of the first exhaust port and the second exhaust port. A valve assembly has a first valve and a second valve. The first valve is positioned in the first exhaust port and the second valve is positioned in the second exhaust port. An actuator is connected to the valve assembly for actuation of the valve assembly.

In another aspect of the present disclosure, the first valve is operated by rotation in a 90-degree arc from a closed position blocking exhaust flow out of the first exhaust port to a fully open position allowing exhaust flow to discharge out of the first exhaust port.

In another aspect of the present disclosure, the second valve is operated by rotating in a 90-degree arc from a closed position blocking exhaust flow out of the second exhaust port to a fully open position allowing exhaust flow to discharge out of the second exhaust port for a full exhaust discharge flow.

In another aspect of the present disclosure, the first valve is positioned in the fully open position allowing an EGR flow of the exhaust gas to be directed back to an engine intake.

In another aspect of the present disclosure, the first valve and the second valve are commonly fixed to a valve shaft positioned within the exhaust manifold.

In another aspect of the present disclosure, the valve shaft is rotated in a 90-degree arc-of-rotation such that one of the first valve or the second valve is fully open while the other one of the first valve or the second valve is fully closed.

In another aspect of the present disclosure, the actuator is positioned external to the exhaust manifold; and the actuator is selectively energized to rotate the valve shaft upon receipt of a rotate command from a command device.

In another aspect of the present disclosure, the exhaust manifold is connected to an engine manifold. The engine manifold includes: multiple exhaust passages in communication with the exhaust ports of the exhaust manifold including an EGR exhaust passage communicating with the first exhaust port of the exhaust manifold and a combined main exhaust passage communicating with the second exhaust port. An exhaust cavity collectively feeds exhaust gas from an exhaust flow split upstream of the first exhaust port and the second exhaust port into the EGR exhaust passage and the combined main exhaust passage.

In another aspect of the present disclosure, the first valve and the second valve define butterfly valves.

In another aspect of the present disclosure, a coolant jacket is positioned within the exhaust manifold to cool exhaust gas, to cool the exhaust manifold and to contribute heat energy to an engine cooling system providing for heat recovery. The coolant jacket has a body with contiguous flow passages extending therethrough providing for flow of a coolant throughout the coolant jacket.

According to several aspects, a vehicle engine exhaust system with integrated exhaust gas recirculation (EGR) includes an exhaust manifold having multiple exhaust ports including a first exhaust port and a second exhaust port. The first exhaust port and the second exhaust port receive exhaust flow from a common exhaust split upstream of the first exhaust port and the second exhaust port. A valve assembly has a first butterfly valve positioned in the first exhaust port and a second butterfly valve positioned in the second exhaust port. A shaft is positioned within the exhaust manifold commonly connecting the first butterfly valve to the second butterfly valve to simultaneously rotate the first butterfly valve and the second butterfly valve.

In another aspect of the present disclosure, an actuator is positioned external to the exhaust manifold and connected to the shaft for actuation of the valve assembly.

In another aspect of the present disclosure, the actuator rotates the shaft in a 90-degree arc-of-rotation.

In another aspect of the present disclosure, the first butterfly valve is positioned on the shaft in a position 90 degrees from the second butterfly valve such that rotation of the shaft in the 90-degree arc-of-rotation oppositely moves the first butterfly valve and the second butterfly valve from a fully closed to a fully open position.

In another aspect of the present disclosure, a coolant jacket is positioned within the exhaust manifold to cool exhaust gas, to cool the exhaust manifold and to contribute heat energy to an engine cooling system providing for heat recovery.

In another aspect of the present disclosure, the coolant jacket includes a body with contiguous flow passages extending therethrough providing for flow of a coolant throughout the coolant jacket.

In another aspect of the present disclosure, the multiple exhaust ports include a third exhaust port and a fourth exhaust port. The second exhaust port, the third exhaust port and the fourth exhaust port are connected to a turbocharger.

According to several aspects, a vehicle engine exhaust system with integrated exhaust gas recirculation (EGR) includes an exhaust manifold. The exhaust includes multiple exhaust ports including a first exhaust port, a second exhaust port, a third exhaust port and a fourth exhaust port. The first exhaust port and the second exhaust port receive an exhaust gas from an exhaust flow split upstream of the first exhaust port and the second exhaust port. A valve assembly has a first butterfly valve and a second butterfly valve. The first butterfly valve is positioned in the first exhaust port and the second butterfly valve is positioned in the second exhaust port. A shaft positioned within the exhaust manifold commonly connects the first butterfly valve to the second butterfly valve to simultaneously rotate the first butterfly valve and the second butterfly valve. The first butterfly valve is positioned on the shaft 90 in a position degrees from the second butterfly valve. An actuator is connected to the shaft for actuation of the valve assembly. Rotation of the shaft in a 90-degree arc-of-rotation oppositely moves the first butterfly valve and the second butterfly valve from a fully closed to a fully open position.

In another aspect of the present disclosure, the third exhaust port and the fourth exhaust port define passive ports for uninterrupted exhaust flow.

In another aspect of the present disclosure, a coolant jacket is positioned within the exhaust manifold to cool exhaust gas, to cool the exhaust manifold and to contribute heat energy to an engine cooling system providing for heat recovery. The coolant jacket has a body with contiguous flow passages extending therethrough providing for flow of a coolant throughout the coolant jacket.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side elevational view of an exhaust manifold according to an exemplary aspect;

FIG. 2 is a top perspective view looking down of the exhaust manifold of FIG. 1 mounted to an exemplary engine manifold;

FIG. 3 is a front perspective view of a coolant jacket adapted to use in the exhaust manifold of FIG. 1;

FIG. 4 is a top right perspective view of a portion of an engine manifold adapted to receive the exhaust manifold of FIG. 1; and

FIG. 5 is a cross sectional top right perspective view taken at section 5 of FIG. 4.

### DETAILED DESCRIPTION

The following description is merely exemplary in nature and is not intended to limit the present disclosure, application, or uses.

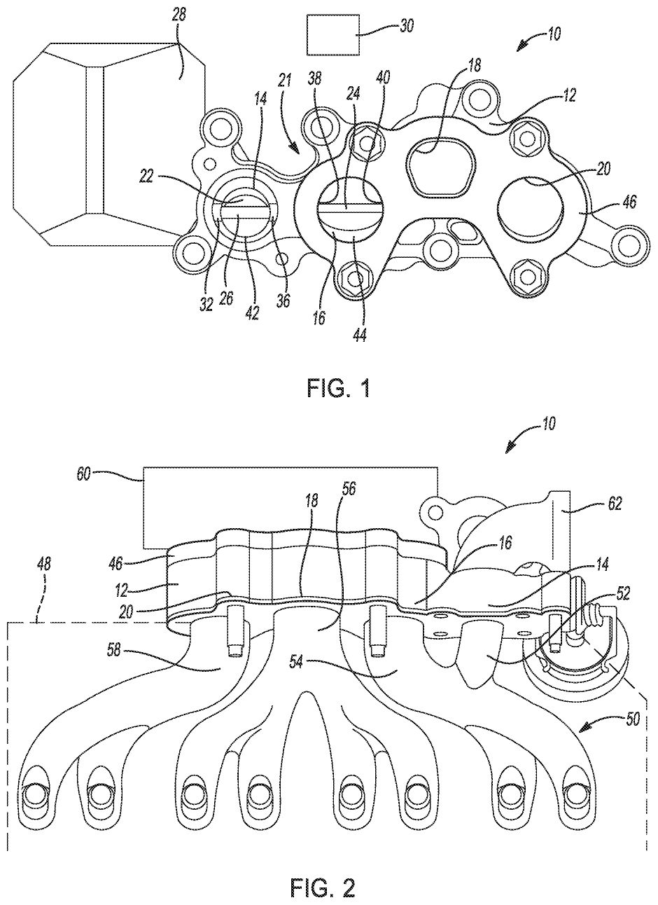

Referring to FIG. 1, an engine exhaust system with integrated EGR valve 10 is provided in an exhaust manifold 12. The exhaust manifold 12 can be cast from a metal such as aluminum or steel. The exhaust manifold 12 includes multiple exhaust ports, which according to an exemplary aspect shown include a first exhaust port 14, a second exhaust port 16, a third exhaust port 18 and a fourth exhaust port 20. According to several aspects, the first exhaust port 14 and the second exhaust port 16 are single-cylinder exhaust ports, receiving exhaust flow from a common engine cylinder, whose exhaust flow can be individually controlled as described below. The first exhaust port 14 and the second exhaust port 16 receive exhaust flow that is split upstream of the first exhaust port 14 and the second exhaust port 16, which is shown and described in greater detail in reference to FIG. 4. The third exhaust port 18 and the fourth exhaust port 20 are passive exhaust ports which are not provided with individual flow control capability and therefore provide uninterrupted exhaust gas flow during engine operation.

The engine exhaust system with integrated EGR valve 10 includes a valve assembly 21 having a first butterfly valve 22 and a second butterfly valve 24. The first butterfly valve 22 is positioned in the first exhaust port 14 and is operated by rotation in a 90-degree arc of rotation from a first butterfly valve closed position blocking exhaust flow from exiting out of the first exhaust port 14 to a first butterfly valve fully open position allowing exhaust flow to discharge out of the first exhaust port 14 to be used for EGR flow. The second butterfly valve 24 is positioned in the second exhaust port 16 and is operated by rotating in a 90-degree rotational arc from a second butterfly valve closed position blocking exhaust flow from exiting out of the second exhaust port 16 during EGR flow to a second butterfly valve fully open position allowing exhaust flow to discharge out of the second exhaust port 16 for maximum exhaust discharge flow from the cylinder communicating with the second exhaust port.

The first butterfly valve 22 and the second butterfly valve 24 are commonly fixed to a valve shaft 26 positioned within the exhaust manifold 12. The first butterfly valve 22 and the second butterfly valve 24 are fixed to the valve shaft 26 with the first butterfly valve 22 in a position axially rotated 90 degrees from a position of the second butterfly valve 24 with respect to a longitudinal axis of the valve shaft 26. The valve shaft 26 is rotated in a 90-degree arc-of-rotation with respect to the longitudinal axis of the valve shaft 26 positioning one of the first butterfly valve 22 or the second butterfly valve 24 in a fully open position allowing flow of exhaust gas while the other one of the first butterfly valve 22 or the second butterfly valve 24 is positioned in a closed position blocking or preventing the exhaust gas from flowing past the closed valve. The valve shaft 26 is connected to an actuator 28 such as an electric motor which rotates the valve shaft 26 with respect to the shaft longitudinal axis upon receipt of a rotate command from a command device 30 such as an engine controller. According to several aspects the actuator 28 is positioned external to the exhaust manifold 12. The command device 30 can be a computer, a control circuit or a similar electronic device which monitors operating conditions of an engine received from various sensors, throttle position, transmission drive position, and the like, compares the operating conditions to criteria and thresholds saved in a memory, and determines when EGR operation is authorized, and therefore when to open the first butterfly valve 22.

The valve shaft 26 is rotatably supported in the exhaust manifold 12 on opposite sides of the first exhaust port 14 by a first bushing 32 and a second bushing 34 to provide rotation and position stability for the first butterfly valve 22 within the first exhaust port 14. The valve shaft 26 is further rotatably supported in the exhaust manifold 12 on opposite sides of the second exhaust port 16 by a third bushing 38 and a fourth bushing 40 to provide rotation and position stability for the second butterfly valve 24 within the second exhaust port 16. A first shoulder 42 provided in the first exhaust port 14 acts as a positive stop for the first butterfly valve 22 in a first butterfly valve 22 closed position. Similarly, a second shoulder 44 provided in the second exhaust port 16 acts as a positive stop for the second butterfly valve 24 in a second butterfly valve 24 closed position. A mounting plate 46 adapted to receive a turbocharger (not shown in this view) is connected to the exhaust manifold 12 having three passageways individually aligned with and positioned to receive exhaust gas flow discharged from the second exhaust port 16, the third exhaust port 18 and the fourth exhaust port 20.

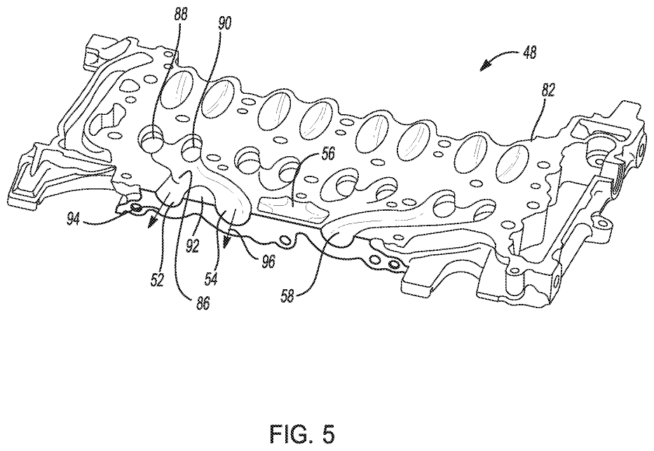

Referring to FIG. 2 and again to FIG. 1, the exhaust manifold 12 is connected to an engine manifold 48, shown in phantom in FIG. 2, and shown and described in greater detail in reference to FIGS. 4 and 5. The engine manifold 48 includes multiple exhaust passages 50 shown with material of the engine manifold 48 removed for clarity. The multiple exhaust passages 50 include an EGR exhaust passage 52 which communicates with the first exhaust port 14 of the exhaust manifold 12, and a combined main exhaust passage 54 which communicates with the second exhaust port 16. A combined second exhaust passage 56 communicates with the third exhaust port 18 and a combined fourth exhaust passage 58 communicates with the fourth exhaust port 20. A turbocharger 60 shown schematically is connected to the mounting plate 46 and receives exhaust flow from the combined main exhaust passage 54, the combined second exhaust passage 56 and the combined fourth exhaust passage 58. A flow connector 62 is mounted to the exhaust manifold 12 which redirects exhaust gas flow for EGR use from the first exhaust port 14 when the first butterfly valve 22 described in reference to FIG. 1 is open.

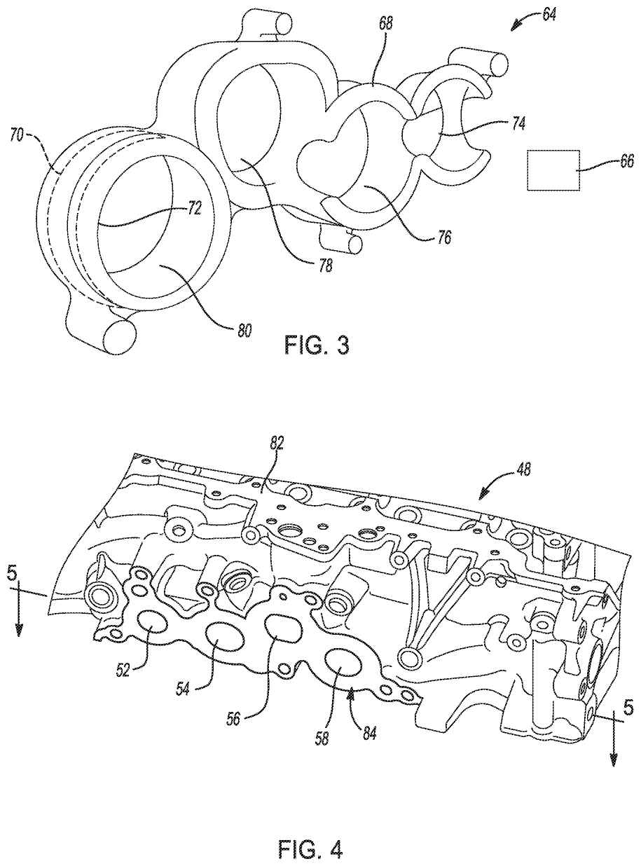

Referring to FIG. 3 and again to FIG. 2, a coolant jacket 64 shown separately from the exhaust manifold 12 for clarity is positioned within the exhaust manifold 12 to cool exhaust gas, to cool the exhaust manifold 12 and to contribute heat energy to an engine cooling system 66 to provide for heat recovery. The coolant jacket 64 has a body 68 with contiguous flow passages 70 extending therethrough, which provide for flow of a coolant 72 throughout the coolant jacket 64. The coolant jacket 64 includes a first jacket opening 74 aligned with the first exhaust port 14 of the exhaust manifold 12, a second jacket opening 76 aligned with the second exhaust port 16, a third jacket opening 78 aligned with the third exhaust port 18 and a fourth jacket opening 80 aligned with the fourth exhaust port 20.

Referring to FIG. 4 and again to FIGS. 1 through 3, an exemplary configuration of the engine manifold 48 is provided. The engine manifold 48 has a cast body 82 of a metal such as aluminum or steel. The EGR exhaust passage 52, the combined main exhaust passage 54 which receives exhaust from a first engine cylinder (cylinders are not shown herein for clarity), the combined second exhaust passage 56 which receives exhaust flow from a second and a third engine cylinder (not shown), and the combined fourth exhaust passage 58 which receives exhaust flow from a fourth engine cylinder (not shown) exit from a planar face 84 onto which the exhaust manifold 12 is mounted, for example using fasteners. It should be apparent that other configurations of an engine manifold modified from engine manifold 48 can also be used within the scope of the present disclosure, including 4-cylinder, 6-cylinder and 8-cylinder or more engine manifolds, with the exhaust manifold 12 adapted to suit the number of cylinders and for different exhaust port quantities and geometries.

Referring to FIG. 5 and again to FIGS. 1 through 4, the EGR exhaust passage 52 and the combined main exhaust passage 54 are collectively fed exhaust gas through an exhaust cavity 86. The exhaust cavity 86 communicates with a first exhaust entrance 88 and a second exhaust entrance 90. A dividing wall 92 is homogeneously connected to the cast body 82 which separates flow from the exhaust cavity 86 into the EGR exhaust passage 52 and the combined main exhaust passage 54. Portions of the combined second exhaust passage 56 and the combined fourth exhaust passage 58 which are not used for EGR operation are also shown. EGR operation directs exhaust gas flow via the exhaust cavity 86 into the EGR exhaust passage 52 in a flow direction 94 and outwardly from the EGR exhaust passage 52 through an open first butterfly valve 22, with the second butterfly valve 24 closed. When EGR operation is not authorized, exhaust gas flow is directed from the exhaust cavity 86 into the combined main exhaust passage 54 in a flow direction 96 and outwardly from the combined main exhaust passage 54 through an open second butterfly valve 24, with the first butterfly valve 22 closed. As previously noted, exhaust flow through the combined second exhaust passage 56 and the combined fourth exhaust passage 58 is passive, and therefore not controlled or limited by the position of a valve.

An engine exhaust system with integrated EGR valve 10 of the present disclosure offers several advantages. These include an EGR valve assembly which is integrated into an exhaust manifold using an existing dual butterfly exhaust valve design. A multi-port manifold has two ports that are valved to determine the exhaust flow path between the ports. According to several aspects, the manifold incorporating the EGR flow paths are water-cooled and contribute to a heat recovery system. One or more ports in the exhaust manifold that are passive for exhaust flow may also be water cooled to further contribute heat energy to an engine cooling system as a means of heat recovery. Incorporating the EGR valves within the exhaust manifold envelope provides a package with minimum sealing interfaces, reducing manufacturing complexity, and eliminates coolant pipes and hoses.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A vehicle engine exhaust system with integrated exhaust gas recirculation (EGR), comprising:
an exhaust manifold including:
multiple exhaust ports including a first exhaust port and a second exhaust port, the first exhaust port and the second exhaust port receiving exhaust flow split upstream of the first exhaust port and the second exhaust port; and
a valve assembly having a first valve and a second valve, the first valve positioned in the first exhaust port and the second valve positioned in the second exhaust port; and
an actuator connected to the valve assembly for actuation of the valve assembly.

2. The vehicle engine exhaust system with integrated EGR of claim 1, wherein the first valve is operated by rotation in a 90-degree arc from a first valve closed position blocking exhaust flow out of the first exhaust port to a first valve open position allowing exhaust flow to discharge out of the first exhaust port.

3. The vehicle engine exhaust system with integrated EGR of claim 2, wherein the second valve is operated by rotating in the 90-degree arc from a second valve closed position blocking exhaust flow out of the second exhaust port to a second valve open position allowing exhaust flow to discharge out of the second exhaust port for a full exhaust discharge flow.

4. The vehicle engine exhaust system with integrated EGR of claim 2, wherein the first valve when positioned in the first valve open position allows an EGR flow of the exhaust gas to be directed back to an engine intake.

5. The vehicle engine exhaust system with integrated EGR of claim 1, wherein the first valve and the second valve are commonly fixed to a valve shaft positioned within the exhaust manifold.

6. The vehicle engine exhaust system with integrated EGR of claim 5, wherein the valve shaft is rotated in a 90-degree arc-of-rotation positioning one of the first valve and the second valve to a fully open position and the other one of the first valve and the second valve to a fully closed position.

7. The vehicle engine exhaust system with integrated EGR of claim 5, wherein:
the actuator is positioned external to the exhaust manifold; and
the actuator is selectively energized to rotate the valve shaft upon receipt of a rotate command from a command device.

8. The vehicle engine exhaust system with integrated EGR of claim 1, wherein the exhaust manifold is connected to an engine manifold, the engine manifold including:
multiple exhaust passages in communication with the exhaust ports of the exhaust manifold including an EGR exhaust passage communicating with the first exhaust port of the exhaust manifold and a combined main exhaust passage communicating with the second exhaust port; and
an exhaust cavity collectively feeding an exhaust gas from an exhaust flow split upstream of the first exhaust port and the second exhaust port into the EGR exhaust passage and the combined main exhaust passage.

9. The vehicle engine exhaust system with integrated EGR of claim 1, wherein the first valve and the second valve define butterfly valves.

10. The vehicle engine exhaust system with integrated EGR of claim 1, further including a coolant jacket positioned within the exhaust manifold to cool exhaust gas, to cool the exhaust manifold and to contribute heat energy to an engine cooling system providing for heat recovery, the coolant jacket having a body with contiguous flow passages extending therethrough providing for flow of a coolant throughout the coolant jacket.

11. A vehicle engine exhaust system with integrated exhaust gas recirculation (EGR), comprising:
an exhaust manifold including:
multiple exhaust ports including a first exhaust port and a second exhaust port, the first exhaust port and the second exhaust port commonly receiving exhaust flow from a common exhaust split upstream of the first exhaust port and the second exhaust port; and
a valve assembly having a first butterfly valve positioned in the first exhaust port and a second butterfly valve positioned in the second exhaust port; and
a shaft positioned within the exhaust manifold commonly connecting the first butterfly valve to the second butterfly valve to simultaneously rotate the first butterfly valve and the second butterfly valve.

12. The vehicle engine exhaust system with integrated exhaust gas recirculation (EGR) of claim 11, further including an actuator positioned external to the exhaust manifold and connected to the shaft for actuation of the valve assembly.

13. The vehicle engine exhaust system with integrated exhaust gas recirculation (EGR) of claim 12, wherein the actuator rotates the shaft in a 90-degree arc-of-rotation.

14. The vehicle engine exhaust system with integrated exhaust gas recirculation (EGR) of claim 13, wherein the first butterfly valve is positioned on the shaft in a position 90 degrees from the second butterfly valve wherein rotation of the shaft in the 90-degree arc-of-rotation oppositely moves the first butterfly valve and the second butterfly valve from a fully closed to a fully open position.

15. The vehicle engine exhaust system with integrated exhaust gas recirculation (EGR) of claim 11, further including a coolant jacket positioned within the exhaust manifold to cool exhaust gas, to cool the exhaust manifold and to contribute heat energy to an engine cooling system providing for heat recovery.

16. The vehicle engine exhaust system with integrated exhaust gas recirculation (EGR) of claim 15, wherein the coolant jacket includes a body with contiguous flow passages extending therethrough providing for flow of a coolant throughout the coolant jacket.

17. The vehicle engine exhaust system with integrated exhaust gas recirculation (EGR) of claim 11, wherein the multiple exhaust ports include a third exhaust port and a fourth exhaust port, the second exhaust port, the third exhaust port and the fourth exhaust port connected to a turbocharger.

18. A vehicle engine exhaust system with integrated exhaust gas recirculation (EGR), comprising:
an exhaust manifold including:
multiple exhaust ports including a first exhaust port, a second exhaust port, a third exhaust port and a fourth exhaust port, the first exhaust port and the second exhaust port receiving an exhaust gas from an exhaust flow split upstream of the first exhaust port and the second exhaust port; and
a valve assembly having a first butterfly valve and a second butterfly valve, the first butterfly valve positioned in the first exhaust port and the second butterfly valve positioned in the second exhaust port;
a shaft positioned within the exhaust manifold commonly connecting the first butterfly valve to the second butterfly valve to simultaneously rotate the first butterfly valve and the second butterfly valve, the first butterfly valve positioned on the shaft in a position rotated 90 degrees from the second butterfly valve; and
an actuator connected to the shaft for actuation of the valve assembly wherein rotation of the shaft in a 90-degree arc-of-rotation oppositely moves the first butterfly valve and the second butterfly valve from a fully closed to a fully open position.

19. The vehicle engine exhaust system with integrated exhaust gas recirculation (EGR) of claim 18, wherein the third exhaust port and the fourth exhaust port define passive ports for uninterrupted exhaust flow.

20. The vehicle engine exhaust system with integrated exhaust gas recirculation (EGR) of claim 18, further including a coolant jacket positioned within the exhaust manifold to cool exhaust gas, to cool the exhaust manifold and to contribute heat energy to an engine cooling system providing for heat recovery, the coolant jacket having a body with contiguous flow passages extending therethrough providing for flow of a coolant throughout the coolant jacket.
